(19) United States
(12) Patent Application Publication
(10) Pub. No.: US 2006/0087606 A1
(43) Pub. Date: Apr. 27, 2006

(54) Portable programmable transmitter for powering and entering images onto an electrical field of a dual electrical field of a bistable light reflective display sign

(76) Inventor: Timothy Alan Munyon, Half Moon Bay, CA (US)

Correspondence Address: Timothy Alan Munyon, 128 Spyglass Lane, Half Moon Bay, CA, 94019, US

(21) Appl. No.: 10/967,689

(22) Filed: Oct. 18, 2004

(51) Int. Cl. G02F 1/1337

(52) U.S. Cl. 349/129

(57) ABSTRACT

The present invention is directed to a portable handheld transmitter device for passing data for posting on a sign display screen. The sign associated with the portable transmitter is of the type having a light reflective rear electrode and a transparent front electrode enclosing a cell which holds an electrically conductive bistable material that upon being electronically addressed creates a stable organized state of the bistable material which is displayed as an image on the sign and also upon application voltage creates a stable random state devoid of image wherein both the organized state and the random state are maintained after cessation of electrical power. The bistable material can alternatively comprise colored particles that are bistable and positioned in a support material; microcapsules containing colored microparticles; or a liquid crystal display material including a chiral nematic; or a cholesteric liquid crystal display material.

### FIELD OF THE INVENTION

The present invention relates to the powering and addressing of dual electrical field bistable display signs associated with light reflective technology.

### BACKGROUND OF THE INVENTION

Display signs addressable by a dual electric field associated with bistable material to provide a light reflective display of an image are known. Three general areas of such technology describe such signs. One area of such technology includes bistable light reflective elements positioned in a liquid carrier and rotatable from one state to another by the application of an electrical field such as disclosed in U.S. Pat. Nos. 4,126,854 and 4,143,103 and many subsequent patents. A second area of such technology includes a dispersion of microcapsules each holding bistable light reflective elements activated to migration from one state to another by the application of an electrical field such as disclosed in U.S. Pat. No. 5,961,804 and many subsequent patents. A third area of such technology includes a bistable liquid crystal display (LCD) including a chiral nematic liquid crystal material such as described in U.S. Pat. No. 5,437,811 and others subsequent or a cholesteric liquid crystal material such as that described in U.S. Pat. Nos. 6,278,429 and 6,320,563 and others subsequent that are changed from one state or texture to another by the application of an electrical field. In accordance with the technical aspect of bistable materials, the cessation of the application of electrical power does not affect the state of the bistable material, either organized state or the random state, including the mentioned rotatable elements, the mobile particles, and the liquid crystal material.

Popular terminology refers to both rotatable element and migrating particle technologies variously as “electric paper,” “electronic paper,” “digital paper,” “e paper” and “e-books.” The rotating element technology is being developed or marketed as “smart paper” by Gyricon (Xerox) while migrating particle technology is being developed or marketed as E Ink by the E Ink Corporation and others including Sony and Royal Phillips. Kent Displays, Inc. develops and markets reflective bistable LCD displays.

Paper that is printed for reading or viewing of images is light reflective in that the typical white sheet, as an example of one color, is light reflective and the black color as an example of a second color is light absorbent. The contrast of the two colors project observable configurations such as print or images to the eye of an observer. In the context of the present invention, an image includes but is not limited to alpha lettering, numerals and associated markings of common text.

A computer screen in contrast uses light emissive technology to send contrasting color images to the eye of an observer. Reflective images have certain advantages over light emissive images as is known in the art.

The recent bistable light reflective technologies do not need continuous electrical power since after the dual electrical field of a display sign is activated as the particular bistable material is addressed and organized, the dual electrical field can thereupon be deactivated and the bistable material remains stable and organized. Subsequent activation of the dual electrical field causes the bistable material to become random. The dual electrical field can then be deactivated and the bistable material remains in the random state so that the display of a sign is clear, that is, devoid of imagry.

The particular type of display sign herein described as presently known in the art is activated generally by radio frequency (RF) or wireless signal technology that activates or deactivates electrical power associated with the display such as a battery mounted in the sign and that also transmits programmed addressing means to the electrode or electrical field for activating the bistable material in the display to an organized state as print or other imagery for viewing by an observer. The converse is true for removal of the imagery on the display, that is, the dual electrical field is temporarily activated to create a state of the bistable material that is random in orientation thus causing the display to become blank..

### SUMMARY OF THE INVENTION

The present invention is directed to a portable handheld transmitter device for passing data for posting on a sign display screen. The sign associated with the portable transmitter is of the type having a light reflective rear electrode and a transparent front electrode enclosing a cell which holds an electrically conductive bistable material that upon being electronically addressed creates a stable organized state of the bistable material which is displayed as an image on the sign and also upon application voltage creates a stable random state devoid of image wherein both the organized state and the random state are maintained after cessation of electrical power. The transmitter includes a housing, a keyboard for entering and sending data mounted in the housing, a microprocessor operationally connected to the keyboard, a word processor, an editing screen and a source of electrical power such as a battery. The sign rear electrode receives the transmittable data from the transmitter and addresses the bistable material in accordance with the transmittable data. A sign transmittable data input line is removably connected to a device transmittable data input line and is electrically connected to the sign rear electrode. A transmittable data input switch positioned in the transmittable data input line is operable between on and off modes. A timer automatically terminates the open mode of the input switch after a predetermined time. Another electrical circuit is activated to send voltage to the sign rear electrode to remove the message on the sign. Means for automatically turning the power line control switch from the on mode to the off mode after a predetermined time is included. The bistable material can alternatively comprise colored particles that are bistable and positioned in a support material; microcapsules containing colored microparticles; or a liquid crystal display material including a chiral nematic or a cholesteric liquid crystal display material. The handheld transmitter includes an insert and the display sign includes a recess that removably connects the electrical power in the handheld transmitter to the dual electric field display sign. The handheld transmitter can be activated so as to allow an operator to enter images generally a text message to the microcomputer mounted in the handheld transmitter with such text message or images being transmitted to and appearing on the transmitter screen.

Handheld programmable devices including devices with a viewing screen are known in the art, such as, for example, handheld calculators. A handheld programmable sign with a standard keyboard and a message screen and holding a battery is disclosed in U.S. Pat. No. 5,973,607 issued to Munyon on Oct. 26, 1999; U.S. Pat. No. 6,177,877 issued to Munyon on Jun. 22, 2004; and U.S. Pat. No.7,753,788 issued to Munyon on Jun. 23, 2001. These devices do not include means for transmitting power and input image data to a display sign having dual electrical fields and a bistable material that can be addressed and activated to create observable images on the display or to be deactivated to clear the images from the display each without continuing application of electrical power.

The present invention will be better understood and the objects and important features, other than those specifically set forth above, will become apparent when consideration is given to the following details and description, which when taken in conjunction with the annexed drawings, describes, illustrates, and shows preferred embodiments or modifications of the present invention and what is presently considered and believed to be the best mode of practice in the principles thereof.

### BRIEF DESCRIPTION OF THE DRAWINGS

FIG. 1 is a top view of the portable programmable transmitter in accordance with the present invention;

FIG. 2 shows a front elevational view of a dual electrical field bistable light reflective sign with a blank display;

FIG. 3 shows a side view of the sign analogous to the view of the sign taken in FIG. 3 also showing spaced from the sign the transmitter of the present invention held by hand;

FIG. 4 shows a side view of the sign analogous to the view shown in FIG. 4 with the transmitter coupled with the rear of the sign;

FIG. 5 shows the sign shown in FIG. 2 with an image message shown on the sign display;

FIG. 6 shows a sectional view of the sign and transmitter taken through line 7-7 in FIG. 6;

FIG. 7 shows an operational schematic view of the transmitter coupled with the sign;

FIG. 8 is a fragment detail front view of the sign showing the sign recess with three ports;

FIG. 9 is a fragment detail front view of the transmitter showing the transmitter insert with three plugs;

FIG. 10 is a view taken through line 10-10 in FIG. 9;

FIG. 11 is a view taken through line 11-11 in FIG. 10; and

FIG. 12 is a view analogous to the view of FIG. 11 with the plug mounted in the port.

### DETAILED DESCRIPTION OF THE INVENTION

Reference is now made in detail to the drawings wherein the same numerals refer to the same or similar elements throughout.

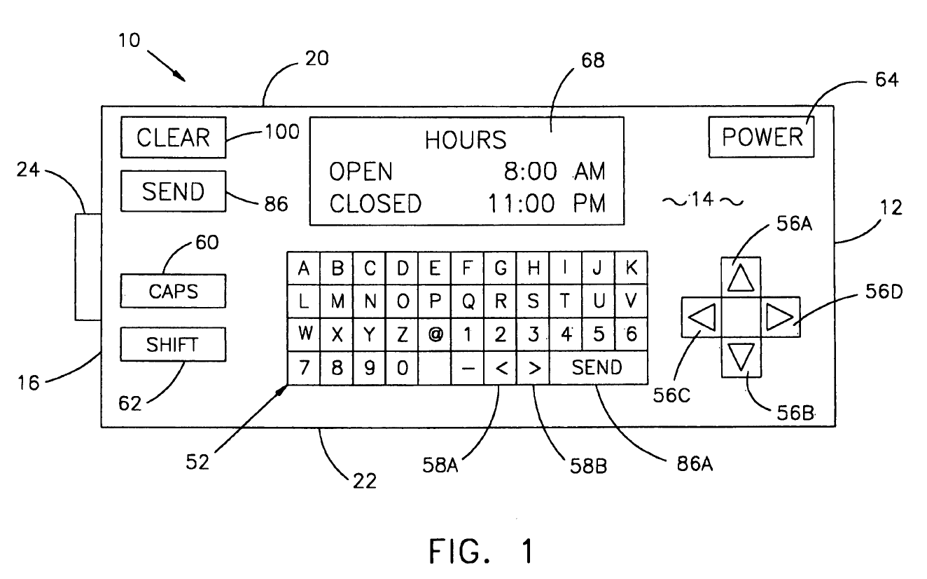

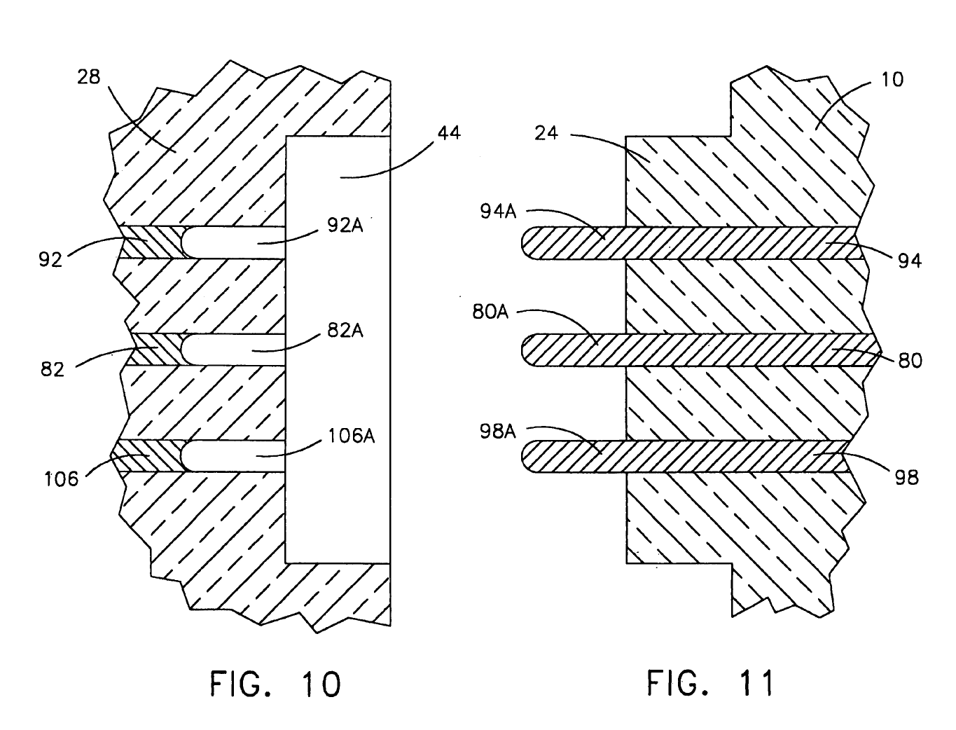

A handheld, or portable, power and programmable transmitter device 10 including a housing 12 having a front side 14 and opposed left and right side walls 16 and 18, respectively, a top side wall 20, a bottom side wall 22 and a rear wall (not shown) is shown in FIG. 1. A transmitter insert 24 seen also in FIGS. 9 and 11 extends from side wall 16. Transmitter 10 is shown being gripped by a hand 26. A light reflective sign 28 shown spaced from transmitter 10 in FIG. 3 includes a rectangular display screen 30 enclosed by a rectangular frame 32 and a transparent front stratum 34 that extends over the area within frame 30 and an opposed rear wall 36. Sign 28 further includes a cell 38 extending within frame 32 that is sandwiched between a transparent front electrode 40 and a rear electrode 42 both of which also extend over the area of frame 32. Front electrode 40 is positioned adjacent to front stratum 34 and rear electrode 42 is positioned adjacent to rear wall 36.

A recess 44 indicated in FIGS. 3, 4, 8 and 10 is defined at the central upper area of rear wall 36. FIG. 4 shows transmitter 10 in operative connection with sign 28 by the positioning of transmitter insert 24 in sign recess 44 wherein transmitter 10 and sign 28 are in temporary operative relationship.

Sign 28 as described and shown herein is of the size and type of sign that is used by a facility such a store or restaurant. Sign 28 is described herein for purposes of exposition only and can vary in size in accordance with various purposes.

A bistable material 46 is contained in cell 38. For purposes of the present application bistable material can be any one of 1) colored particles that are bistable and positioned in a support material; 2) microcapsules containing colored microparticles that are bistable; and 3) a liquid crystal display material including either a chiral nematic or a cholesteric liquid crystal display material. Each of these three bistable material display systems have been described hereinbefore.

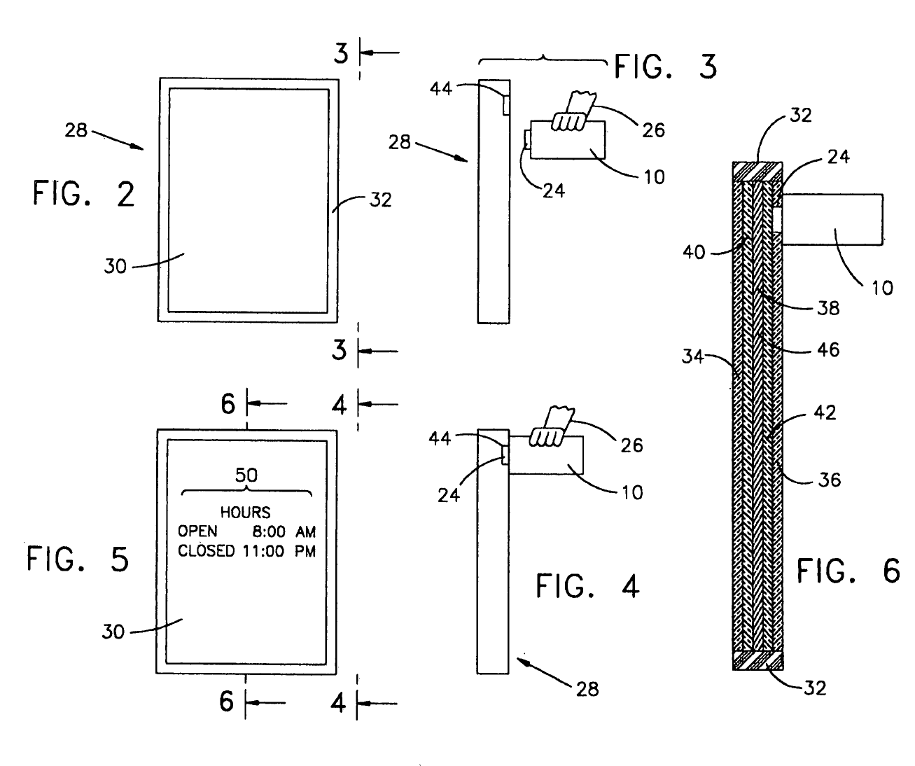

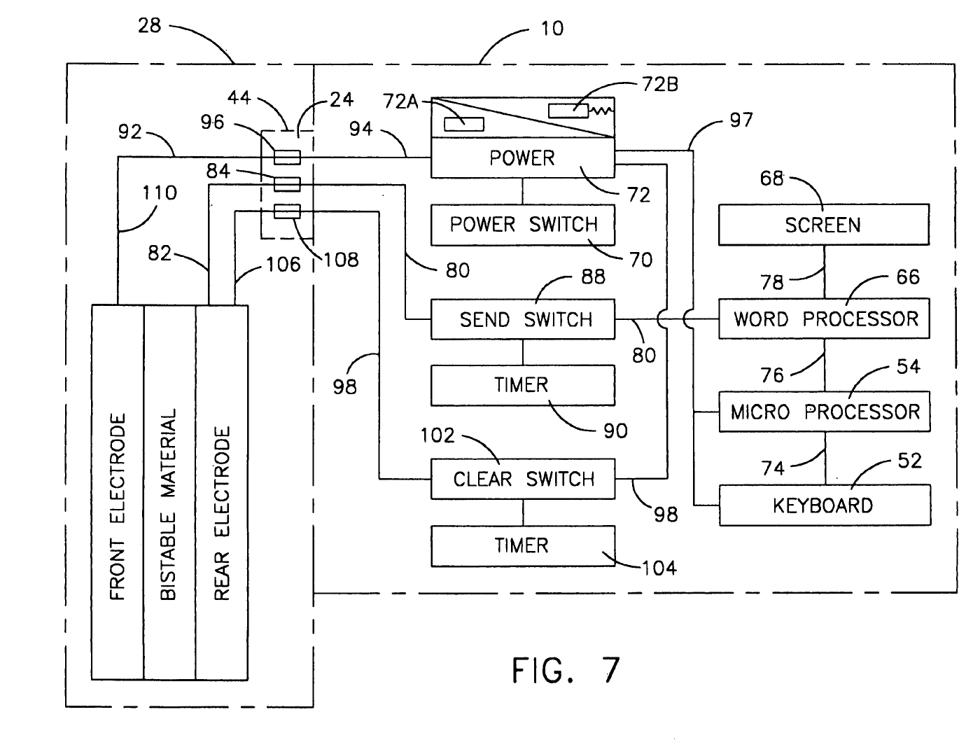

When display screen 30 is blank, that is, devoid of an image such as a text message, as shown in FIG. 2, and an image such as a text message is desired to be shown on display screen 30, rear electrode 42 is addressed by way of programmable transmitter 10 by way of an application of voltage from a power source 48 mounted in programmable transmitter 10 in a manner known in the art so as to create a new state of bistable material 46 that is transformed into an organized state so as to form a desired image that is transmitted in an observable form from display screen 30 by light reflective means. For example a text message 50 as shown in FIG. 5 can be read by an observer by the contrast between light reflected from display screen 30 by selected bistable material 46 and by light absorbed by selected bistable material 46 in accordance with the addressing of the totality of bistable material 46 by rear electrode 42. For purposes of exposition, text message 50 is shown on display screen 30 as follows:

HOURS

| | |
|---|---|
| OPEN | 8 AM |
| CLOSED | 11 PM |

Termination of voltage to rear electrode 42 and thus eventually to display screen 30 will not change the organized state of bistable material 46 as is known in the art of bistable material with the result that bistable material 46 continues to maintain its organized state without a continuing application of voltage so text message 50 remains unchanged. Transmitter 10 as shown in FIG. 1 includes a keyboard 52 that includes alpha letters A to Z, numerals 0-9, “at” symbol @, a period key, a dash key, and a spacer key all of which are operationally connected to a microprocessor 54 shown in FIG. 7 that is embedded within transmitter 10. Keyboard 52 also includes up, down, left and right cursor alignment function keys 56A, B, C and D, respectively. Keyboard 52 also includes support operation signal capabilities such as spacer keys 58A and 58B, a capital letter CAPS lock key 60, and a capital letter SHIFT key 62. Transmitter 10 also includes a power function key 64. Additional function keys known in the art can be optionally added, for example, underlining and bold function keys. Transmitter 10 as seem in FIG. 1 also includes an image processor that is shown as word processor 66 and an optional editing screen 68.

As seen in FIG. 7, operation of transmitter 10 is initiated by operation of power function key 64 that operates a power switch 70 between on and off modes that operates a power source 72 positioned in transmitter 10. Power source 72 is preferably a dc battery source of power. Power source 72 is alternatively a battery internal power source 72A or an external power source 72B that is connected to an alternating source of external source of power such as a wall power outlet. Power source 72B preferably includes an ac-dc converter. Activation of power 72 initiates delivery of voltage to the entire system of transmitter 10 including keyboard 52. Operation of keyboard 52 results in input data associated with text message 50 being sent by a data input line 74 to microprocessor 54 where the signals are processed for further transmittal by a processed data input line 76 to word processor 66 and thereupon transmittable data input signals are sent by a transmitter data input line 78 to editing screen 68 where a programmed preview of text message 50 is viewed for possible editing by the operator for conformance to the desired text message 50. Editing changes can be made at keyboard 52.

An input data electrical circuit for posting test message 50 on sign display screen 30 includes a transmitter data input line 80 positioned in transmitter 12 Transmitter data input line 80 is electrically and operationally connected to word processor 66.and is removably and electrically connected to a sign data input line 82 at an electrical connector 84 positioned in recess 44 with transmitter insert 24 also positioned therein. Electrical connection at connector 84 is operationally complete when transmitter insert 24 is positioned in recess 44 and transmitter input data line 80 is removably connected to sign data input line 82 which is in electrical connection with rear electrode 42. A function send key 86 mounted in housing 12 as shown in FIG. 1 is operationally connected to a send data input switch 88 mounted in housing 12 that is in operational connection with transmitter data input line 80 and is operable between on and off modes by activation of send key 86. Alternatively, a send function key 86A can be located on adjacent to keyboard A timer 90 in operational contact with send switch 88 automatically terminates the open mode of switch 88 after a predetermined period of time. A voltage limitation device can optionally be operationally mounted on transmitter data input line 80. A sign electrical return line 92 removably connects front electrode 40 with a transmitter electrical return line 94 that is connected to power source 70. Both sign electrical return line 92 and transmitter electrical return line 94 are removably connected to an electrical return connector 96 that is positioned in recess 44 and to insert 24. A transmitter power line 97 from power source 70 to microprocessor 54 and keyboard 52 completes the electrical source.

A power electrical circuit for clearing text message 50 from sign display screen 30 includes a transmitter power input line 98 connected to power source 70. A clear function key 100 mounted on housing 12 operationally connected to a clear switch 102 is positioned on transmitter power input line 98 operates clear switch between open and closed modes. A timer 104 in operational contact with clear switch 102 automatically terminates the open mode of switch 102 after a predetermined period of time. A voltage limitation device can optionally be operationally mounted on transmitter power input line 98. Transmitter power input line 98 is also removably and electrically connected to a sign power input line 106 at a power electrical connector 108. Electrical connection at connector 108 is operationally complete when transmitter insert 24 is positioned in recess 44 and transmitter power input line 98 is removably connected to sign power input line 106.

Sign power input line 106 is electrically connected to front electrode 40. A sign power return line 110 is optionally is the same mutatis mutandis as sign electrical return line 92 in sign 28 and is electrically removably connected to transmitter electrical return line 94 at electrical return connector 96 and to power source 70.

After insertion of transmitter insert 24 into sign recess 44, activation of power source 72 by operation of power function key 64 and power switch 70 allows the operator to enter text message 50 at keyboard 52 with the resulting data being sent to microprocessor 54 from where the processed data being sent to word processor 66 and to transmitter screen 68 for proofing and possible correction at keyboard 52. At this time, the operator activates function send key 78 so as to open send switch 88 for the transfer of transmittable data relating to text message 50 from word processor 66 to sign transmittal data input line 82 and rear electrode 42 which addresses bistable material 46 from a disorganized or random state into the organized state of text message 50, which becomes readable by an observer on sign display screen 30 by light reflective means. Power source 72 is automatically turned off by timer 90. After text message 50 is shown on sign display screen 30, operation of power function key 64 turns power switch 70 to the off mode so as to deactivate power source 72. The operator then removes transmitter 10 from connection with sign 28 at recess 44.

When the operator desires to remove text message 50 from sign display screen 30, transmitter 10 is electrically connected with sign 28 by inserting insert 24 into recess 44 and then operating power function key 64 so as to activate power source 70. Operation of a clear function key 100 turns on clear power switch 102 so as to transmit electrical power by way of a transmitter power line 104 connected to power source 72 to a sign power line 106 at an electrical connector 108 positioned in sign recess 44 which electrically connects transmitter power input line 98 to sign power input line 106. Voltage passes from sign power input line 106 to rear electrode 42 and then to bistable material 46 which is changed from a stable organized state to a stable disorganized or random state with the result that text message 50 is removed from display screen 30, that is, display screen 30 is devoid of a message. Completion of the message removal electrical circuit is complete by voltage passing from front electrode 40 to sign power return line 110 and to transmitter electrical line 94 and power source 72. The activation of power function key 64 results in power source 70 being deactivated. The operator then removes transmitter 10 from connection with sign 28, in particular from sign recess 44.

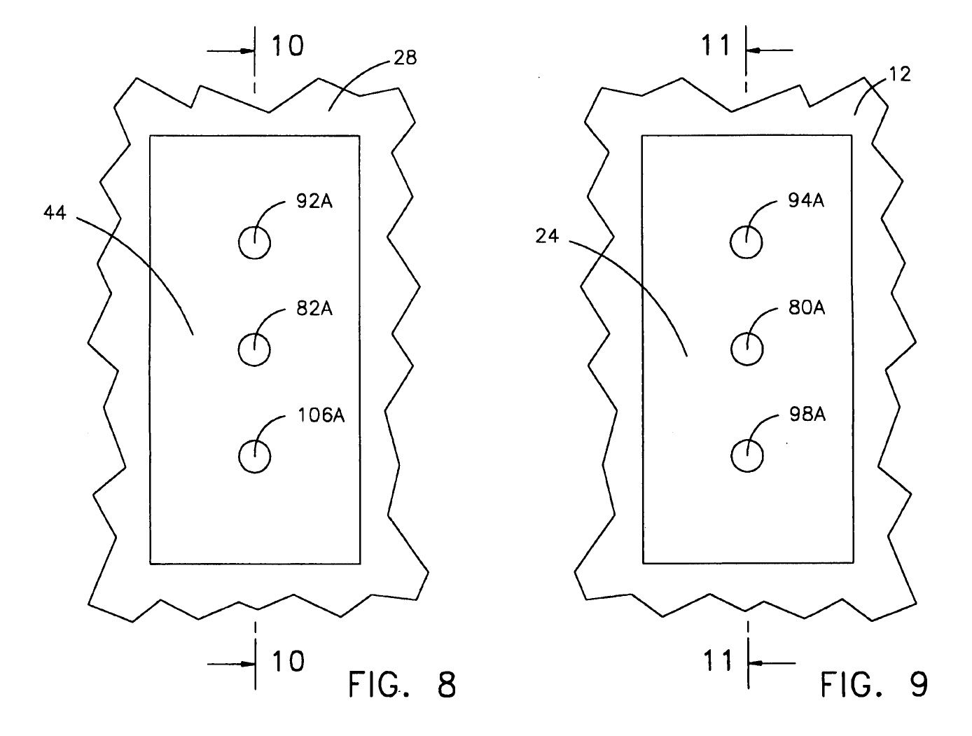

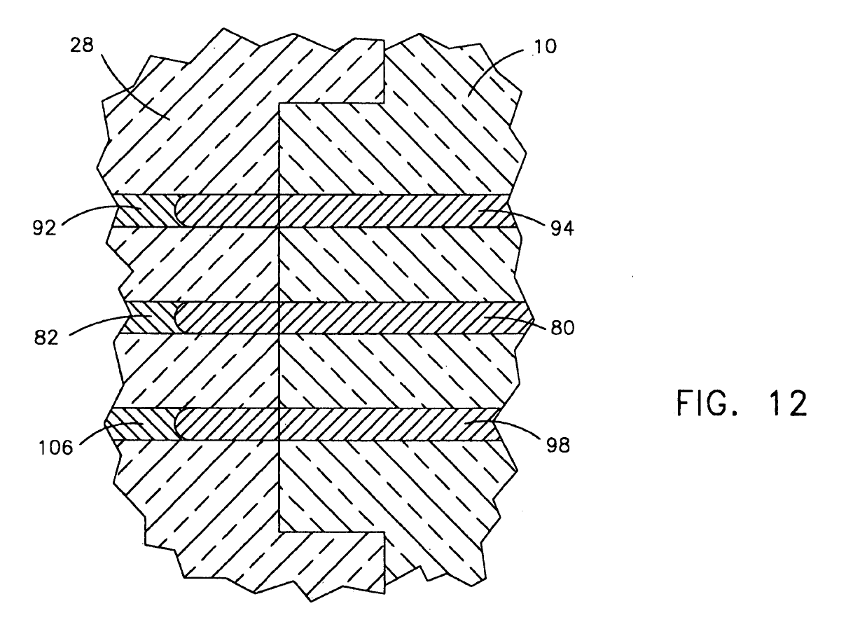

FIGS. 8, 9, 10 and 11 show sign recess 44 and transmitter insert 24 in a separated mode prior to the placement of insert 24 into recess 44, which is shown in FIG. 12. Transmitter data input line 80, transmitter electrical return line 94 and transmitter power input line 98 are indicated in FIG. 11 terminating in plugs 80A, 94A and 98A. Sign electrical return line 92, sign data input line 82 and sign power input line 106 terminate at sign electrical sockets 92A, 82A and 106A, respectively, which are adapted to receive plugs 80A, 94A and 98A, respectively, so as to make electrical connectors 96, 84 and 108, respectively, the latter being indicated in FIG. 7.

Other embodiments or modifications may be suggested to those having the benefit of the teachings therein, and such other embodiments or modifications are intended to be reserved especially as they fall within the scope and spirit of the subjoined claims.

What is claimed is:

1. A device used in conjunction with a light reflective sign having a sign display and having a rear and a transparent front electrodes enclosing a cell which holds an electrically conductive bistable material that upon being electronically addressed creates a stable organized state of the bistable material which is displayed as an image and also upon application voltage creates a stable random state devoid of image wherein both the organized state and the random state are maintained after cessation of electrical power, comprising,
a portable housing,
a keyboard for entering and sending data mounted in said housing,
a microprocessor operationally connected to said keyboard for receiving and converting said data to processed data, said microprocessor being mounted in said housing,
means for receiving and converting said processed data to transmittable data, said means for receiving and converting being mounted in said housing,
electrode means for receiving said transmittable data and addressing the bistable material in accordance with said transmittable data,
a device transmittable data input line mounted in said housing, said device transmittable data input line being electrically connected to said means for receiving and converting,
a sign transmittable data input line removably connected to said device transmittable data input line and electrically connected to the rear electrode, said sign transmittable data input line being mounted in said sign,
a device transmittable data input switch positioned in said housing on said device transmittable data input line, said transmittable data input switch being operable between on and off modes.
a sign electrical output line electrically connected to said front electrode, said sign electrical output line being mounted in said sign, the front electrode electronically addressing the bistable material with the transmittable data, wherein the sign display shows indicia in accordance with the transmittable data,
a device electrical output line removably connected to said sign electrical output line and electrically connected to said microprocessor, said device electrical output line being mounted in said housing,
an electrical circuit comprising said device transmittable data input line, said sign transmittable data input line, the rear electrode, the bistable material, said front electrode, said sign electrical output line, said device electrical output line, said microprocessor, and said keyboard, and
means for supplying power to said electrical circuit and to said microprocessor, said keyboard, said means for receiving and converting, said means for supplying power being associated with said housing and having a power on and a power off switch.

2. The device according to claim 1, further including means for automatically terminating the open mode of said input switch after a predetermined time.

3. The device according to claim 2, further including means for limiting the power to said data input line, said means for limiting the power to said data input line being a voltage regulator.

4. The device according to claim 1, further including a sign power line electrically connected to the rear electrode, said sign power line being mounted in said sign, and a device power line removably connected to said sign power line and to said means for supplying power, said device power line being mounted in said housing, said device power line being electrically connected to said means for supplying power, wherein another electrical circuit comprises the electrical connection of said sign power line, the rear electrode, the front electrode, said device power line, and said means for supplying power.

5. The device according to claim 4, further including a power line control switch positioned in said housing in operative association with said device power line, said power line control switch being operable between on and off modes.

6. The device according to claim 5, further including means for automatically turning said power line control switch from the on mode to the off mode after a predetermined time.

7. The device according to claim 5, further including means for limiting the power from said device power line to said sign power line, said means for limiting the power being a voltage regulator.

8. The device according to claim 1, further including device screen means for receiving said transmittable from said means for receiving and converting and further for displaying said transmittable data as indicia, said screen means being mounted in said housing in association with said electrical circuit.

9. The device according to claim 1, wherein the bistable material comprises colored particles that are bistable and positioned in a support material;

10. The device according to claim 1, wherein the bistable material comprises microcapsules containing colored microparticles.

11. The device according to claim 1, wherein the bistable material is a liquid crystal display material.

12. The device according to claim 11, wherein said liquid crystal display material is a cholesteric liquid crystal display material.

13. The device according to claim 11, wherein said liquid crystal display material is a chiral nematic liquid crystal display material.

14. The device according to claim 1, wherein said indicia processor is a word processor

15. The device according to claim 1, wherein said sign includes first port means for removably connecting said sign data input line with said device data input line

16. The device according to claim 14, wherein said device includes first plug means for removably connecting said device data input line with said sign data input means, said first plug means being insertable into said first port means.

17. The device according to claim 16, wherein said sign includes second port means for removably connecting said sign electrical output line with said device electrical output line.

18. The device according to claim 17, wherein said device includes second plug means for removably connecting said device electrical output line with said sign electrical output line, said second plug means being insertable into said second port means.

19. The device according to claim 18, wherein said device includes third port means for removably connecting said sign power line with said device power line,

20. The device according to claim 19, wherein said means for removably connecting said sign power line with said device power line includes third plug means for removably connecting said device power line with said sign power line, aid third plug means being insertable into said third port means.

21. The device according to claim 20, wherein said sign defines a sign recess, said first port means, said second port means and said third port means being positioned in said recess.

22. The device according to claim 21, further including a device insert connected to and extending outwardly from said device, said first plug means, said second plug means and said third plug means being positioned in said insert, said device insert being positioned in said sign recess in the operable mode of said device.

23. The device according to claim 1, wherein said means for supplying power is an internal source of power including at least one battery.

24. The device according to claim 1, wherein said means for supplying power includes an external source of power including a device power line extension connected to the external source of power.

25. The device according to claim 1, wherein said means for supplying power includes a direct current source of power.

26. The device according to claim 1, wherein said means for supplying power includes an alternating current source of power.
